(19) United States
(12) Patent Application Publication
(10) Pub. No.: US 2026/0106255 A1
(43) Pub. Date: Apr. 16, 2026

(54) BATTERY PROCESSING METHOD AND BATTERY PROCESSING SYSTEM

(71) Applicant: MAZDA MOTOR CORPORATION, Hiroshima (JP)

(72) Inventors: Susumu MINEOI, Hiroshima (JP); Tenyu YAN, Hiroshima (JP); Kenjiro MOMOSAKI, Hiroshima (JP); Tomoki YAMAMOTO, Hiroshima (JP)

(73) Assignee: MAZDA MOTOR CORPORATION, Hiroshima (JP)

(21) Appl. No.: 19/357,217

(22) Filed: Oct. 14, 2025

(30) Foreign Application Priority Data
Oct. 11, 2024 (JP) 2024-179272

(51) Int. Cl. H01M 10/54; C22B 26/12

(52) U.S. Cl. CPC H01M 10/54; C22B 26/12

(57) ABSTRACT

A battery processing method for processing a lithium-ion battery including a positive electrode material, a negative electrode material, and an electrolytic solution and configured by laminating the positive electrode material and the negative electrode material in a lamination direction includes a lithium deposition step of charging the lithium-ion battery by increasing a pressing force in the lamination direction on a central portion in a plane perpendicular to the lamination direction in comparison with remaining portions to deposit lithium on the negative electrode material.

### CROSS-REFERENCE TO RELATED APPLICATION

The present application claims priority to Japanese Patent Application 2024-179272, filed Oct. 11, 2024, the entire contents of which are incorporated herein by reference.

### FIELD

Embodiments relate to a battery processing method and a battery processing system.

### BACKGROUND

In recent years, lithium-ion batteries have been widely used as in-vehicle batteries of electric-powered vehicles such as electric vehicles and hybrid vehicles. The lithium-ion battery contains valuable substances including lithium. It is requested to recycle valuable substances from the used lithium-ion batteries for resource circulation.

The following method is disclosed in Patent Literature 1. In the method, the used lithium-ion battery is discharged to increase an amount of lithium contained in a positive electrode material, and then lithium is collected from the positive electrode material.

### CITATION LIST

### Patent Literature

[Patent Literature 1] JP-A-2022-049831

### SUMMARY

The positive electrode material is generally configured by forming a positive electrode active material on a current collector foil such as aluminum. For example, in a case of a ternary system (NMC), the positive electrode active materials include the valuable substances such as nickel, manganese, and cobalt. In order to collect the valuable substances from the positive electrode active material, the positive electrode material is roasted together with a reducing agent and pulverized, and then a black mass or the like containing the positive electrode active material is selected. Next, the black mass is subjected to stepwise solvent extraction to sequentially extract manganese, cobalt, and nickel, and finally lithium is extracted. Thus, it takes time and effort to collect lithium in particular.

One or more embodiments may provide provide a battery processing method and a battery processing system capable of efficiently collecting lithium from a lithium-ion battery.

One or more embodiments may provide
a battery processing method for processing a lithium-ion battery including a positive electrode material, a negative electrode material, and an electrolytic solution and configured by laminating the positive electrode material and the negative electrode material in a lamination direction, the battery processing method including:
a lithium deposition step of charging the lithium-ion battery 1 by increasing a pressing force in the lamination direction on a central portion in a plane perpendicular to the lamination direction in comparison with a remaining portion to deposit lithium on the negative electrode material.

One or more embodiments may provide a battery processing system including:
a charging device that charges a lithium-ion battery including a positive electrode material and a negative electrode material and configured by laminating the positive electrode material and the negative electrode material in a lamination direction; and
a pressing device that presses a central portion in a plane perpendicular to the lamination direction of the lithium-ion battery by increasing a pressing force in comparison with a remaining portion.

### ADVANTAGEOUS EFFECTS

According to an embodiment, lithium can be efficiently collected from a negative electrode of the lithium-ion battery.

### BRIEF DESCRIPTION OF DRAWINGS

FIG. 1 is a block diagram schematically illustrating a reuse system according to the present embodiment.

FIG. 2 is a perspective view illustrating a schematic configuration of a lithium-ion battery.

FIG. 3 is a cross-sectional view illustrating a schematic configuration of a battery cell.

FIG. 4 is a view illustrating a schematic configuration of a pressing device.

FIG. 5 is a flowchart schematically illustrating a flow of reuse of the lithium-ion battery.

### DETAILED DESCRIPTION

The present inventors have conducted intensive studies to efficiently collect lithium from a lithium-ion battery, and have found that lithium can be efficiently collected from the lithium-ion battery by intentionally generating lithium deposition (for example, dendrite), which is not desirable in a normal charging reaction, on a negative electrode material. Based on this finding, the present inventors have completed a battery processing method capable of efficiently collecting lithium from the lithium-ion battery.

A method for reusing a lithium-ion battery according to an embodiment of the invention includes
a battery processing method for processing a lithium-ion battery including a positive electrode material, a negative electrode material, and an electrolytic solution and configured by laminating the positive electrode material and the negative electrode material in a lamination direction, the battery processing method including:
a lithium deposition step of charging the lithium-ion battery 1 by increasing a pressing force in the lamination direction on a central portion in a plane perpendicular to the lamination direction in comparison with a remaining portion to deposit lithium on the negative electrode material.

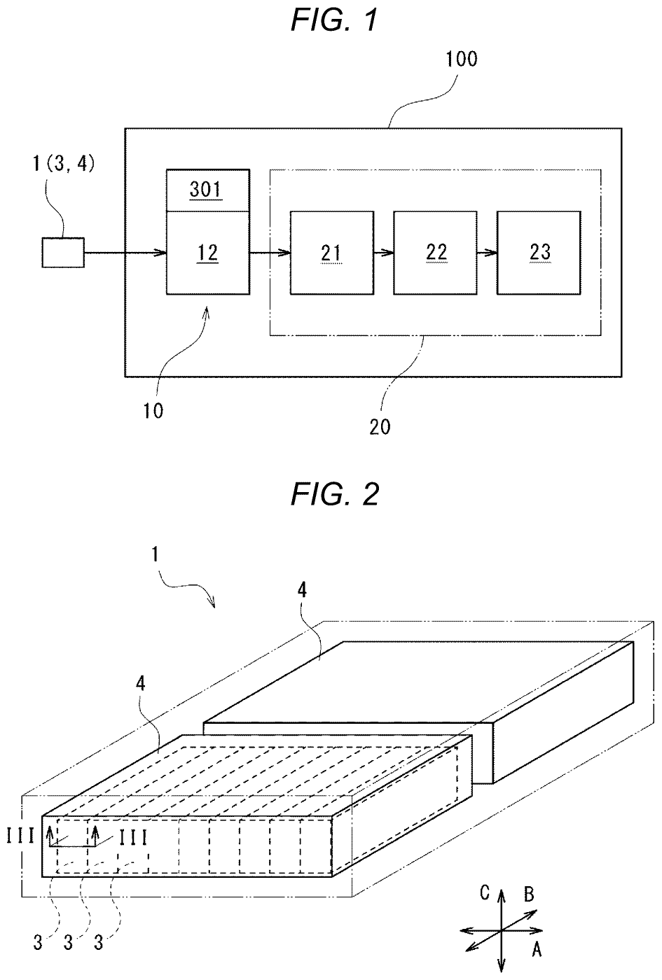

Hereinafter, a reuse system of a lithium-ion battery according to the present embodiment will be described with reference to the accompanying drawings. FIG. 1 is a block diagram schematically illustrating a reuse system 100 of a lithium-ion battery 1. As illustrated in FIG. 1, the reuse system 100 includes: a reuse unit 10 secondarily using the lithium-ion battery 1 that has been used primarily in an electric-powered vehicle, for example; and a recycle unit 20 collecting lithium from the lithium-ion battery 1 that has been used secondarily. That is, the reuse system 100 is a battery processing system for secondarily using the lithium-ion battery 1 and thereafter collecting lithium from the lithium-ion battery 1, in other words, for processing the lithium-ion battery 1.

The reuse unit 10 reuses the lithium-ion battery 1, which has been used primarily, as an electrical storage device. In general, a deteriorated state of the lithium-ion battery for the electric-powered vehicle is determined on the basis of state of health (SOH) that indicates, for example, how much capacity is available in comparison with a new battery when the battery is fully charged. When it is determined that the lithium-ion battery 1 is inappropriate for use in the electric-powered vehicle on the basis of a degree of the deterioration, the lithium-ion battery 1 is removed from the vehicle, and is used in the reuse unit 10 as the electrical storage device for any of various secondary applications, such as a storage of renewable energy including solar power and wind power and a backup power source in the event of a disaster. For example, when the SOH becomes 70% or less, it may be determined to be inappropriate for the primary use, that is, for use in the electric-powered vehicle.

The reuse unit 10 includes the lithium-ion battery 1, which is used secondarily as the electrical storage device, a charging device 12, and a pressing device 301. The charging device 12 can charge the lithium-ion battery 1 in any appropriate charging pattern by adjusting a voltage and a current. For example, the lithium-ion battery 1 can be charged continuously with a predetermined voltage and a predetermined current, and can also be charged intermittently with the predetermined voltage and the predetermined current (also referred to as pulse charging). An upper limit of a charging voltage by the charging device 12 is a withstand voltage of the lithium-ion battery 1 or less, and is 4.3 V or less, for example. The pressing device 301 will be described in detail after a description on a structure of the lithium-ion battery 1.

The recycle unit 20 includes: a disassembly device 21 that disassembles the lithium-ion battery 1 into a positive electrode material 31, a negative electrode material 35, and the like through a lithium deposition step described below when it is determined that the lithium-ion battery 1 can be inappropriate for secondary use on the basis of the SOH, for example; an extraction device 22 that extracts lithium from the negative electrode material 35 after the disassembly; and a collection device 23 that collects extracted lithium. For example, when the SOH becomes 40% or less, it may be determined that it can be inappropriate for the secondary use.

FIG. 2 schematically illustrates the lithium-ion battery 1 that is mounted on the electric-powered vehicle. The lithium-ion battery 1 constitutes a battery pack having battery modules 4, each of which incorporates functions as a charge/discharge circuit and a cooling mechanism. Furthermore, the plural battery modules 4 are connected to each other and accommodated in a case. Each of the battery modules 4 is formed by connecting plural battery cells 3 in series or in parallel with each other, and is adjusted to desired capacity and a desired voltage.

The lithium-ion battery 1 is a rechargeable lithium-ion secondary battery. In the present specification, the term “lithium-ion battery” may collectively refer to the battery cell, the battery module, and the battery pack unless otherwise specified.

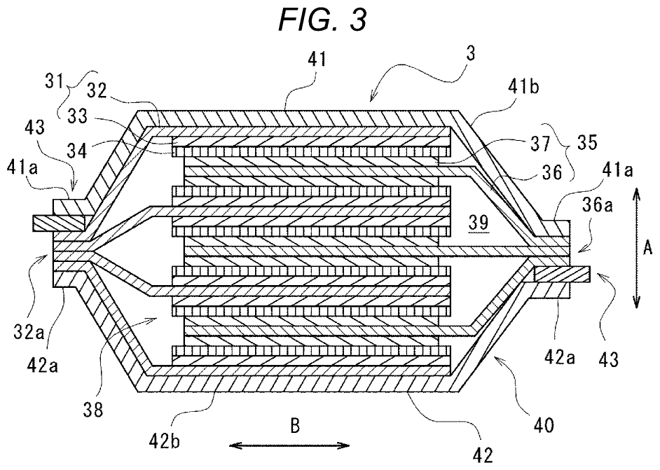

FIG. 3 is a cross-sectional view schematically illustrating the battery cell 3. As illustrated in FIG. 3, the battery cell 3 according to the present embodiment is of a laminated type. The battery cell 3 includes: a laminated electrode body 38 in which the positive electrode material 31, a separator 34, and the negative electrode material 35 are laminated in this order in a lamination direction A; and a case 40 that accommodates the laminated electrode body 38.

In the present embodiment, the laminated electrode body 38 is formed by laminating plural sets of the positive electrode material 31, the separator 34, and the negative electrode material 35 in the lamination direction A. The battery cell 3 has a rectangular shape that is thin and long in a width direction B when viewed in the lamination direction A.

The positive electrode material 31 includes a positive electrode current collector 32 and a positive electrode active material 33 that is disposed on a surface of the positive electrode current collector 32 facing the separator 34. In a positive electrode current collector end portion 32a, the plural positive electrode current collectors 32 are connected to each other at one end (a left side in FIG. 3) in the width direction B that is orthogonal to the lamination direction A. A metal foil suitable for a positive electrode can be suitably used for each of the positive electrode current collectors 32. A material that is used as a positive electrode active material of a lithium-ion secondary battery can be used as the positive electrode active material 33. In the present embodiment, each of the positive electrode current collectors 32 is made of aluminum, and the positive electrode active material 33 is made of NMC (nickel, manganese, and cobalt).

The negative electrode material 35 includes a negative electrode current collector 36 and a negative electrode active material 37 that is disposed on a surface of the negative electrode current collector 36 facing the separator 34. In a negative electrode current collector end portion 36a, the plural negative electrode current collectors 36 are connected to each other at the other end (a right side in FIG. 3) in the width direction B. A metal foil suitable for a negative electrode can be suitably used for each of the negative electrode current collectors 36. A material that is used as a negative electrode active material of the lithium-ion secondary battery can be used for the negative electrode active material 37. In the present embodiment, each of the negative electrode current collectors 36 is made of copper, and the negative electrode active material 37 is a carbon material (graphite) that has a layer structure.

The positive electrode active material 33 and the negative electrode active material 37 each contain an electrolytic solution 39. The electrolytic solution 39 is, for example, an organic solvent in which lithium ions can move. In the present embodiment, the electrolytic solution 39 contains dimethyl carbonate (DMC), ethylene carbonate (EC), and diethyl carbonate (DEC) in a volume ratio of 1:1:1, and contains lithium hexafluoride phosphate (LiPF₆) at a concentration of 1 mol/L.

The separator 34 is disposed between the positive electrode material 31 and the negative electrode material 35, and physically and electrically separates them from each other. The separator 34 may be a porous body having plural minute pores through which the lithium ions can pass. In the present embodiment, the separator 34 is a porous film that is made of polyolefin.

The case 40 has a first case 41 and a second case 42 that are provided as a pair on both sides in the lamination direction A of the laminated electrode body 38. The first case 41 and the second case 42 are each formed to have a hat-shaped cross section. The first case 41 includes: a pair of flange portions 41a located at both ends in the width direction B; and a body portion 41b that is located between the paired flange portions 41a and bulges in a direction away from the second case 42 in the lamination direction A. Similarly, the second case 42 includes a pair of flange portions 42a and a body portion 42b that bulges in a direction away from the first case 41.

The first case 41 and the second case 42 are joined to each other in a state of sandwiching the positive electrode current collector end portion 32a and the negative electrode current collector end portion 36a between the flange portions 41a, 42a, and thereby constitute the case 40. That is, in a state where the laminated electrode body 38 is accommodated in the case 40, the positive electrode current collector end portion 32a and the negative electrode current collector end portion 36a are sandwiched between the paired flange portions 41a, 42a, and a remaining portion of the laminated electrode body 38 is accommodated in a space that is defined between the paired body portions 41b, 42b. In the state of being accommodated in the case 40, the laminated electrode body 38 is crimped with a predetermined pressure in the lamination direction A by the paired body portions 41b, 42b. An example of a tab 43 according to the invention is formed by a portion, which is sandwiched by the paired flange portions 41a, 42a, in the battery cell 3.

In the present embodiment, such a situation is assumed that the deterioration of the lithium-ion battery 1 relatively progresses, and in particular, the electrolytic solution 39 is depleted in a peripheral edge portion 3z of the battery cell 3.

Next, the pressing device 301 will be described. The pressing device 301 is a device that presses the battery cell 3 with a predetermined pressing force in the lamination direction A. In order to generate a charging/discharging reaction in the lithium-ion battery 1, the pressing device 301 may be provided to the lithium-ion battery 1 that has been primarily used in the electric-powered vehicle, or may be provided to the lithium-ion battery 1 that has been secondarily used in the reuse unit 10. Alternatively, a pressing device that can automatically or manually adjust a pressing force may be provided separately. The pressing device 301 may include a suitable actuator such as a hydraulic cylinder or a pneumatic cylinder.

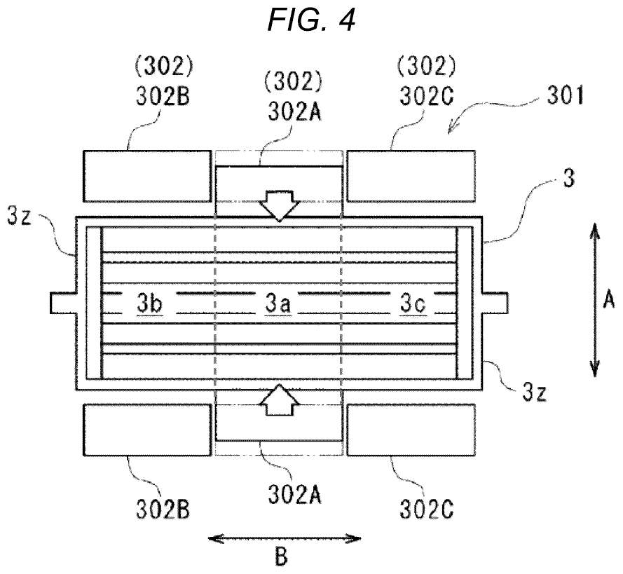

FIG. 4 is a view schematically illustrating the pressing device 301. FIG. 4 schematically illustrates the battery cell 3 that is pressed by the pressing device 301. As illustrated in FIG. 4, the pressing device 301 includes plural sets of presser pairs 302, each set of which is provided as a pair on both sides of the battery cell 3 in the lamination direction A, and which are divided in the width direction B of the battery cell 3. In the present embodiment, the pressing device 301 includes: a central presser pair 302A located at a center in the width direction B; a one-side or first side presser pair 302B located on one side (a first or left side in FIG. 4) in the width direction B; and an other-side or second side presser pair 302C located on the other side (a second or right side in FIG. 4) in the width direction B. A number of the presser pairs 302 may be three, or may be two, four, or more.

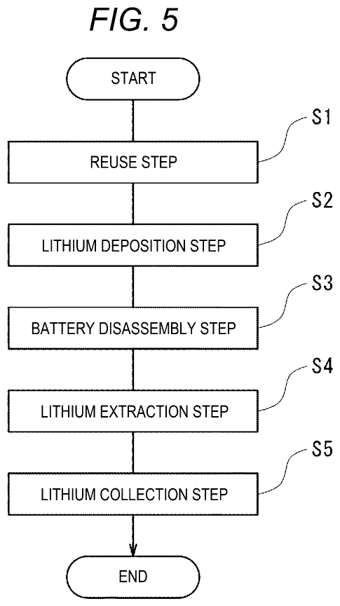

Next, reuse of the lithium-ion battery 1 will be described. FIG. 5 is a flowchart schematically illustrating a flow of reuse of the lithium-ion battery 1. As illustrated in FIG. 5, when it is determined that the lithium-ion battery 1, which is mounted on the electric-powered vehicle, is in the deteriorated state that is not suitable for use in the electric-powered vehicle on the basis of the SOH, for example, a reuse step (step S1) is executed. In the reuse step S1, the lithium-ion battery 1 is removed from the electric-powered vehicle and used secondarily in the reuse unit 10.

In a case where it is determined that the lithium-ion battery 1 is in a predetermined deteriorated state after being used secondarily as the electrical storage device, a lithium deposition step (step S2) is executed following the secondary use in the reuse unit 10. In the lithium deposition step S2, the lithium-ion battery 1 is charged while being pressed in the lamination direction A under a predetermined pressing condition.

In the lithium deposition step S2, the battery cell 3 is locally pressed by operating at least some presser pairs 302 of the plural sets of the presser pairs 302. More specifically, as illustrated in FIG. 4, only a central portion 3a in the width direction B of the battery cell 3 is pressed by operating only the central presser pair 302A, which is located on the central portion in the width direction B and/or the height direction C of the battery cell 3, among the plural sets of the presser pairs 302. Accordingly, in the lithium deposition step S2, the battery cell 3 is pressed by increasing the pressing force in the lamination direction A on the central portion 3a in a plane perpendicular to the lamination direction A in comparison with the remaining portions 3b, 3c.

For example, in a case where the presser pairs 302 are substantially equally divided into four in the width direction B, only the two inner presser pairs 302 may be operated in the width direction B. In addition, in a case where the presser pairs 302 are arranged to be substantially equally divided into five in the width direction B, only the three inner presser pairs 302 in the width direction B or only the central presser pair 302 in the width direction B may be operated. That is, in the lithium deposition step S2, a portion, which includes the central portion 3a but does not include the peripheral edge portion 3z, in the battery cell 3 may be pressed.

In general, in order to generate the charging/discharging reaction in the lithium-ion battery 1, the battery cell 3 has to be pressed (that is, constrained) in the lamination direction. In the lithium deposition step S2, the battery cell 3 is pressed with the pressing force for at least generating the charging/discharging reaction. For example, the pressing force is 10 kPa or greater and 1 MPa or less.

“[I]ncreasing the pressing force in the lamination direction A on the central portion 3a in comparison with the remaining portions 3b, 3c” also means reducing the pressing force in the remaining portions 3b, 3c in a state where the entire battery cell 3 is uniformly pressed. For example, it is included in the lithium deposition step S2 to reduce or release pressing of the remaining portions 3b, 3c in the lithium-ion battery 1 that is secondarily used in the reuse unit 10, that is, being entirely and uniformly pressed. As described above, in a case where the lithium deposition step S2 is performed using the pressing device provided in the lithium-ion battery 1 that has been secondarily used, compared to a case where the lithium deposition step S2 is performed by separately attaching the pressing device to the lithium-ion battery 1, it is possible to perform work efficiently without requiring time and effort of attachment.

In the lithium deposition step S2, the lithium-ion battery 1 is charged to deposit lithium on the negative electrode material 35 in a state where the central portion 3a of the battery cell 3 is locally pressed by the pressing device 301.

In the present embodiment, lithium is deposited on the negative electrode material 35 by charging the lithium-ion battery 1 by high-rate charging. The high-rate charging means charging with a large current that intentionally generates lithium in the negative electrode material 35 during charging.

For example, when the lithium-ion battery 1 is of a so-called capacitive type (also referred to as an energy type) that is mounted on an electric vehicle, it may be charged with a current of 2 C or greater, for example. Meanwhile, when the lithium-ion battery 1 is of a so-called high-output type (also referred to as a power type) that is mounted on a hybrid vehicle, it may be charged with the current of 10 C or greater, for example. Here, the current of 1 C means a current that is required to fully charge each of the lithium-ion batteries in one hour. Lithium can be deposited on the negative electrode material 35 by the continuous high-rate charging for a predetermined time.

In the present specification, the lithium-ion battery 1 being of the capacitive type means a case where the energy density thereof is 600 Wh/L or greater. In addition, the lithium-ion battery 1 being of the high-output type means a case where output density thereof is 4000 kW/L or greater.

When the charging current in the high-rate charging becomes excessively large, unfavorable side reactions, such as gasification of the electrolytic solution 39 and deformation and damage of each component, possibly occur due to heat generation. Thus, from a viewpoint of energy saving, excessive charging current is not preferable. For example, when the lithium-ion battery 1 is of the capacitive type, an upper limit of the charging current may be set to about 3 C. Meanwhile, when the lithium-ion battery 1 is of the high-output type, the upper limit of the charging current may be set to about 20 C.

In addition, when the lithium-ion battery 1 is charged, the pressing force on the central portion 3a is increased. In this way, the charging reaction can be accelerated (e.g., concentrated) in the negative electrode material 35 that corresponds to the central portion 3a. Furthermore, in both of the side portions 3b, 3c of the battery cell 3, the electrolytic solution is likely to flow to the outside from the peripheral edge portion 3z and thus to be depleted. Meanwhile, since the central portion 3a is separated from the peripheral edge portion 3z, the electrolytic solution 39 is likely to remain. Thus, by increasing the pressing force in the central portion 3a in which the electrolytic solution 39 is likely to remain, lithium is easily and efficiently deposited on the negative electrode material 35 corresponding to the central portion 3a. As a result, the charging current is concentrated in a place where the electrolytic solution 39 remains and the charging reaction is accelerated. Thus, the high-rate charging is performed partially, and local deposition of lithium is facilitated.

Here, in the lithium deposition step S2, the lithium-ion battery 1 only needs to be charged in the pressed state. A pressing step of the lithium-ion battery 1 by the pressing device 301 and charging of the lithium-ion battery 1 by the charging device 12 may be started simultaneously, or one thereof may be started first. That is, after the pressing step by the pressing device 301 is executed, the charging device 12 may execute a charging step while the pressed state by the pressing device 301 is maintained.

Next, the lithium-ion battery 1 is removed from the reuse unit 10, and a battery disassembly step (step S3) is executed by the disassembly device 21. In the battery disassembly step S3, the lithium-ion battery 1 is disassembled into components such as the positive electrode material 31, the separator 34, the negative electrode material 35, and the case 40. When only lithium is intended to be collected, at least the negative electrode material 35 may only be disassembled. The disassembly device 21 may be any appropriate device that automatically disassembles the lithium-ion battery 1. Here, the lithium-ion battery 1 may be disassembled manually by using a tool or the like without using the disassembly device 21.

Next, a lithium extraction step (step S4) is executed. In the lithium extraction step S4, lithium is extracted from the disassembled negative electrode material 35. In the lithium extraction step S4, after exuding the negative electrode material 35 with water, the extraction device 22 filters the negative electrode material 35 to remove the negative electrode current collector 36 and the negative electrode active material 37, and thereby extracts an aqueous solution containing lithium ions. In the lithium extraction step S4, lithium is selectively extracted from the portion, which corresponds to the central portion 3a on which lithium is deposited locally, in the negative electrode material 35 in the lithium deposition step S2. Which negative electrode material 35 of the plural disassembled negative electrode materials 35 has the portion corresponding to the central portion 3a can be visually identified, or can be identified on the basis of the portion (that is, the central portion 3a) pressed by the pressing device 301. This makes it possible to extract lithium further efficiently.

Finally, a lithium collection step (step S5) is executed. In the lithium collection step S5, lithium is collected from the aqueous solution containing lithium ions. In the lithium collection step S5, after subjecting lithium to a solution treatment with carbonated water, the collection device 23 filters the solution and collects lithium as lithium carbonate.

In the above embodiment, the case where the presser pair 302 is divided in the width direction B of the battery cell 3 has been described as an example. However, it may be divided in a height direction C orthogonal to the lamination direction A and the width direction B of the battery cell 3, or may be further divided in both the width direction B and the height direction C.

That is, the battery processing method according to the present embodiment is
the battery processing method for processing the lithium-ion battery 1 including the positive electrode material 31, the negative electrode material 35, and the electrolytic solution 39 and configured by laminating the positive electrode material 31 and the negative electrode material 35 in the lamination direction A, the battery processing method including:
the lithium deposition step S2 of charging the lithium-ion battery 1 by increasing the pressing force in the lamination direction A on the central portion 3a in the plane perpendicular to the lamination direction A in comparison with the remaining portions 3b, 3c to deposit lithium on the negative electrode material 35.

As a result, since the negative electrode material 35 is generally formed by laminating graphite on the current collector foil, such as copper, in the form of the layer, it contains less types of valuable substances than the positive electrode material 31 that has plural types of the valuable substances such as cobalt, nickel, and manganese. Accordingly, unlike a case where lithium is collected from the positive electrode material 31, stepwise solvent extraction of plural types of the valuable metals does not require time and effort. Thus, lithium can be efficiently collected from the negative electrode material 35. In addition, by increasing the pressing force on the central portion 3a, in which the electrolytic solution 39 is relatively likely to remain, in the lithium-ion battery 1, lithium is easily and locally deposited on the portion of the negative electrode material 35 corresponding to the central portion 3a. As a result, lithium can be collected further efficiently.

In the lithium deposition step S2, the high-rate charging is performed.

As a result, lithium can be intentionally deposited on the negative electrode material 35 by the high-rate charging.

In the lithium extraction step S4, lithium is selectively extracted from the portion of the negative electrode material 35 corresponding to the central portion 3a.

As a result, lithium can be extracted further efficiently.

The reuse system 100 of the lithium-ion battery 1 may correspond to the configuration described in the above embodiment, or various modifications can be made thereto.

In the above embodiment, the description has been made on the example in which the lithium-ion battery is of the laminated type. In an implementation, a lithium-ion battery in a cylindrical shape or a polygonal shape may be adopted, which is formed by winding a belt-shaped laminated electrode body, in which a belt-shaped positive electrode material, a belt-shaped separator, and a belt-shaped negative electrode material are laminated in the lamination direction A, in a cylindrical shape or a square shape. In a case of the cylindrical shape or the polygonal shape, the lamination direction corresponds to a radial direction orthogonal to a winding direction.

Although the description has been made on a cell-by-cell basis, it may be implemented on a module-by-module basis or on a battery pack-by-battery pack basis. In a case of the implementation on the battery pack-by-battery pack basis, the pressing device may be provided in the battery pack in advance.

In the lithium deposition step S2, the high-rate charging may not be performed. That is, when being of the capacitive type, the lithium-ion battery 1 may be charged with the current of less than 2 C, for example. Meanwhile, when being of the high-output type, the lithium-ion battery 1 may be charged with the current of less than 10 C, for example.

### REFERENCE SIGNS LIST

1: lithium-ion battery
3: battery cell
4: battery module
10: reuse unit
12: charging device
20: recycle unit
21: disassembly device
22: extraction device
23: collection device
31: positive electrode material
34: separator
35: negative electrode material
38: laminated electrode body
39: electrolytic solution
40: case
100: reuse system
301: pressing device

1. A battery processing method for processing a lithium-ion battery including a positive electrode material, a negative electrode material, and an electrolytic solution and configured by laminating the positive electrode material and the negative electrode material in a lamination direction, the battery processing method comprising:
a lithium deposition step of charging the lithium-ion battery and increasing a pressing force in the lamination direction on a central portion of the lithium-ion battery in a direction perpendicular to the lamination direction and not increasing the pressing force on a remaining portion of the lithium-ion battery to deposit lithium on the negative electrode material.

2. The battery processing method according to claim 1, wherein, in the lithium deposition step, the charging is performed by high-rate charging.

3. The battery processing method according to claim 2, wherein the high-rate charging is charging the lithium ion battery with a current equal to or greater than 2 C.

4. The battery processing method according to claim 1, further comprising:
a battery disassembly step of disassembling at least the negative electrode material from the lithium-ion battery after the lithium deposition step; and
a lithium extraction step of extracting lithium from the negative electrode material.

5. The battery processing method according to claim 4, wherein, in the lithium extraction step, lithium is selectively extracted from a portion of the negative electrode material corresponding to the central portion.

6. The battery processing method according to claim 1, further comprising:
a battery disassembly step of disassembling at least the negative electrode material from the lithium-ion battery after the lithium deposition step; and
a lithium extraction step of extracting lithium from the negative electrode material.

7. The battery processing method according to claim 1, wherein:
the pressing force is increased by using a pressing device that includes a plurality of presser pairs, each presser pair is on opposite sides of the lithium-ion battery in the lamination direction, and each presser pair is divided in a width direction of the lithium-ion battery, and
the lithium-ion battery is charged in a state where the lithium-ion battery is locally pressed by operating only some presser pairs of the plurality of presser pairs.

8. The battery processing method according to claim 1, wherein:
the pressing force is increased by using a pressing device that includes a plurality of presser pairs, each presser pair is on opposite sides of the lithium-ion battery in the lamination direction,
the pressing device includes: a central presser pair located at a center in a width direction of the lithium-ion battery; a first side presser pair located on one side of the lithium-ion battery in the width direction; and a second side presser pair located on another side of the lithium-ion battery in the width direction, and
at least one of the first side presser pair and the second side presser pair is not actuated during application of the pressing force.

9. The battery processing method according to claim 1, wherein the pressing force is 10 kPa or greater and 1 MPa or less.

10. A battery processing system, comprising:
a charging device that charges a lithium-ion battery including a positive electrode material and a negative electrode material and configured by laminating the positive electrode material and the negative electrode material in a lamination direction; and
a pressing device that presses a central portion in a plane perpendicular to the lamination direction of the lithium-ion battery by increasing a pressing force in the lamination direction in comparison with a remaining portion.

11. The battery processing system according to claim 10, wherein the charging device is configured to charge the lithium-ion battery by performing high-rate charging.

12. The battery processing system according to claim 11, wherein the high-rate charging is charging the lithium ion battery with a current equal to or greater than 2 C.

13. The battery processing system according to claim 10, wherein:
the pressing device includes a plurality of presser pairs, each presser pair is on opposite sides of the lithium-ion battery in the lamination direction, and each presser pair is divided in a width direction of the lithium-ion battery, and
the charging device is configured to charge the lithium-ion battery in a state where the lithium-ion battery is locally pressed by operating only some presser pairs of the plurality of presser pairs.

14. The battery processing system according to claim 10, wherein:
the pressing device that includes a plurality of presser pairs, each presser pair is on opposite sides of the lithium-ion battery in the lamination direction,
the pressing device includes: a central presser pair located at a center in a width direction of the lithium-ion battery; a first side presser pair located on one side of the lithium-ion battery in the width direction; and a second side presser pair located on another side of the lithium-ion battery in the width direction, and
at least one of the first side presser pair and the second side presser pair is not actuated during application of the pressing force.

15. The battery processing system according to claim 10, wherein the pressing force is 10 kPa or greater and 1 MPa or less.
